(19) United States
(12) Patent Application Publication
(10) Pub. No.: US 2007/0053466 A1
(43) Pub. Date: Mar. 8, 2007

(54) Frequency shift keying demodulation technique

(76) Inventor: Daniel Joseph Klostermann, Valencia, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/222,170

(22) Filed: Sep. 8, 2005

(51) Int. Cl. H04L 27/00

(52) U.S. Cl. 375/316; 128/903; 607/32; 607/60

(57) ABSTRACT

Improved digital FSK demodulator methods and circuitry are disclosed. The demodulation method can be implemented using a standard microcontroller such as is usually already present in a telemetry receiving device. The demodulation method is simple and, when a microcontroller is used, easy to implement using standard portions of the microcontroller (e.g., the UART) and/or through programming. In a preferred embodiment, the demodulation circuitry comprises a delay line, preferably a shift register comprising part of the microcontroller's UART. The shift register delays samples of the received FSK modulated signal by a number of cycles so as to introduce a 90-degree delay. The received signal samples, and their delayed counterparts, are input to an XOR gate, whose output reflects whether a logic ‘0’ or ‘1’ has been received by the device, although filtering of this output make this determination more reliable. The circuitry can sample the received telemetered modulated signal at relatively low rates, thus saving power and microcontroller resources for other tasks. Only minimal analog components are required to receive and process the received signal beyond the microcontroller, greatly simplifying the demodulation circuitry.

### FIELD OF THE INVENTION

The present invention relates generally to a low-power, simple-circuit implementation of a technique for demodulating a telemetered signal, e.g., a signal telemetered to an implantable medical device, such as a pulse generators used in a Spinal Cord Stimulation (SCS) systems or other type of neural stimulation systems.

### BACKGROUND

Implantable stimulation devices generate and deliver electrical stimuli to body nerves and tissues for the therapy of various biological disorders, such as pacemakers to treat cardiac arrhythmia, defibrillators to treat cardiac fibrillation, cochlear stimulators to treat deafness, retinal stimulators to treat blindness, muscle stimulators to produce coordinated limb movement, spinal cord stimulators to treat chronic pain, cortical and deep brain stimulators to treat motor and psychological disorders, and other neural stimulators to treat urinary incontinence, sleep apnea, shoulder sublaxation, etc. The present invention may find applicability in all such applications, although the description that follows will generally focus on the use of the invention within a Spinal Cord Stimulation (SCS) system, such as that disclosed in U.S. patent application Ser. No. 11/177,503, filed Jul. 8, 2005, which is incorporated herein by reference in its entirety.

Spinal cord stimulation is a well-accepted clinical method for reducing pain in certain populations of patients. An SCS system typically includes an Implantable Pulse Generator (IPG) or Radio-Frequency (RF) transmitter and receiver, electrodes, at least one electrode lead, and, optionally, at least one electrode lead extension. The electrodes, which reside on a distal end of the electrode lead, are typically implanted along the dura of the spinal cord, and the IPG or RF transmitter generates electrical pulses that are delivered through the electrodes to the nerve fibers within the spinal column. Individual electrode contacts (the “electrodes”) are arranged in a desired pattern and spacing to create an electrode array. Individual wires within one or more electrode leads connect with each electrode in the array. The electrode lead(s) exit the spinal column and generally attach to one or more electrode lead extensions. The electrode lead extensions, in turn, are typically tunneled around the torso of the patient to a subcutaneous pocket where the IPG or RF transceiver is implanted. Alternatively, the electrode lead may directly connect with the IPG or RF transceiver. For examples of other SCS systems and other stimulation systems, see U.S. Pat. Nos. 3,646,940 and 3,822,708, which are hereby incorporated by reference in their entireties. Of course, implantable pulse generators are active devices requiring energy for operation, such as is provided by an implanted battery or an external power source.

FIGS. 1-3 introduce various components of an exemplary SCS system, although further details will be explained more fully later. As particularly relevant to the present discussion, the SCS components comprise implantable components 10 (i.e., components implantable or implanted into a patient requiring therapy) and external components 20 (i.e., components external to the patient but which work in conjunction with the internal components 10). As seen in FIG. 1, the implantable components 10 include an implantable pulse generator (IPG) 100, which may comprise a rechargeable, multi-channel, telemetry-controlled, pulse generator. The external components 20 include a remote control 202, otherwise known as a hand-held programmer (HHP) 202, which may be used to control the IPG 100 via a suitable non-invasive communications link 201, e.g., an RF link. Such control allows the IPG 100 to be turned on or off, and generally allows stimulation parameters, e.g., pulse amplitude, width, and rate, to be set within prescribed limits. Detailed, system-level programming of the IPG 100 may additionally be accomplished through the use of an external clinician's programmer (CP) 204, which may also be hand-held and which may be coupled to the IPG 100 directly via an RF link 201a or indirectly using the HHP 202 as an intermediary. These RF links 201, 201a are preferably two-way links that can be used to send data to (i.e., control) the IPG 100, or to receive data from the IPG 100.

Such RF telemetry between the HHP 202 or CP 204 and the IPG 100 is supported via circuitry in the IPG 100, as shown in FIG. 3. Among other components and circuitry which will be described in further detail later, the IPG 100 comprises RF-telemetry circuitry 172, which receives RF telemetry data from the external components 20 (such as desired IPG operating parameters) and which sends RF telemetry data to the external components 20 (e.g., to allow the IPG 100's operating parameters to be verified, to allow the IPG 100's identification number to be reported, etc.).

In recognition of the fact that the RF telemetry through links 201 and 201a would generally comprise use of a modulated carrier, RF-telemetry circuitry 172 would preferably include demodulator circuitry 262. Exemplary frequency demodulation circuitry useable in an IPG 100, as well as other components of the RF-telemetry circuitry 172, is shown in FIG. 5. What is shown for simplicity is an analog FM demodulation circuit, but one skilled in the art will recognize that it can be implemented digitally as well, and preferably would be implemented digitally in an implantable stimulator application. (In a digital implementation, some of the circuit elements shown would not be used, such as the LC circuit and mixer).

The operation of the demodulation circuitry is known to one skilled in the art, and hence is only briefly described. Essentially, data is sent to the IPG 100 (via RF links 201, 201a) as a sequence of bits represented by a variance in frequency (121 kHz, 129 kHz) from a center carrier frequency (f_{c}=125 kHz). After passing the received signal through a band pass filter to remove frequencies outside of the frequency range of interest, a phase shift (φ) is induced in the received signal via an LC circuit for example, in which the phase shift is a function of the frequency of the received signal. By mixing the phase shifted signal with the original received signal, and sending the result through a low pass filter to remove high-frequency components, a voltage (proportional to ½ cos(φ)) is generated which is compared to a threshold to determine whether the received signal comprised a 121 kHz signal (a logical ‘0’) or a 129 kHz signal (a logical ‘1’). As noted earlier, digital demodulation is logical in an implantable medical device application, and could for example comprise use of the QFAST RF protocol, which supports bi-directional telemetry at, e.g., 8 Kbits/second. (QFAST stands for “Quadrature Fast Acquisition Spread Spectrum Technique,” and represents a known and viable modulation and demodulation technique for data telemetry).

Demodulation techniques could use improvement, especially as applied to low-power and/or small-size devices such as implantable stimulator devices, implantable medical devices more generally, or even non-medical or non-implantable devices. Taking the example of implantable stimulator devices, because such devices are to be implanted in a patient, they are preferably as small as possible. Analog demodulation approaches require analog hardware (capacitors, inductors, etc.) that may be too big for the device. Digital demodulation techniques may likewise involve the use of several digital components for which space may not be available in the implantable stimulator device. In this regard, implementation of the QFAST protocol generally involves the use of chips or chip sets dedicated to this function, as well as other discrete components. Additionally, digital demodulation may involve digital signal processing (DSP) techniques that are too complicated to practically implement in such a device.

Continuing with the example of an implantable stimulator device, either analog or digital demodulation schemes may also draw too much power. As should be appreciated, an IPG must ultimately draw power to function and to provide stimulation pulses to the patient in which it is implanted. Regardless of whether an IPG is powered by a non-rechargeable battery, is powered by a battery rechargeable via an RF energy source (e.g., charger 208, FIG. 1), or is solely powered via an RF energy source, power consumption in an IPG is preferably kept to a minimum. For example, in the case of an IPG with a rechargeable battery, lower power consumption equates to longer periods in which the IPG can be used to provide stimulation between charges. Accordingly, excessive power draw from the demodulation circuitry in the RF-telemetry circuitry 172 is regrettable, as it subtracts from the power that can be used for patient therapy. It is therefore preferred that such circuitry be kept as simple as possible.

Accordingly, demodulation circuitry and techniques which exhibit low power consumption and/or simpler circuit implementations would be beneficial in a host of applications and fields. Such solutions are provided herein.

### SUMMARY

Improved digital Frequency Shift Keying (FSK) demodulation methods and circuitry, particularly useful when implemented in an implantable medical device, such as an implantable stimulator device, is disclosed. The demodulation method is largely implementable using a microcontroller such as that already normally present in an IPG for handling other functions, i.e., the microcontroller processes signals other than the received telemetered data. The demodulation method is simple and, when a microcontroller is used, easy to implement using standard portions of the microcontroller (e.g., the UART) and/or through programming.

In a preferred embodiment, the demodulation method comprises a circuit to sample the received modulated signal, a delay line, an XOR function (implemented in either hardware or software), and a low pass filter function (implemented in either hardware or software). The delay line is preferably a shift register comprising part of the microcontroller's UART. The shift register delays the sampled received signal by a number of sampling clock cycles so as to preferably introduce delays to the signal which are centered at 90 degrees. The received signal samples, and their delayed counterparts, are input to an XOR gate, whose output reflects whether a logic ‘0’ or a logic ‘1’ has been received by the IPG, although filtering of this output is preferable to more reliably make this determination. The circuitry can sample the incoming modulated signal at relatively low rates, thus saving power and microcontroller resources for other tasks. Only minimal analog components are required to receive the telemetered signal, and in a preferred embodiment no other dedicated circuitry is needed to implement the demodulation function, greatly simplifying the IPG's receipt of telemetry from an external component such as a hand-held programmer or a clinician's programmer.

While noted as particularly useful when implemented in implantable medical devices, the disclosed demodulation circuitry and techniques can benefit any device or communication system in which low power consumption and/or simpler circuit implementations are beneficial.

### BRIEF DESCRIPTION OF THE DRAWINGS

The above and other aspects of the present invention will be more apparent from the following more particular description thereof, presented in conjunction with the following drawings wherein:

FIG. 1 shows a block diagram that illustrates exemplary implantable, external, and surgical components of a spinal cord stimulation (SCS) system that employs an implantable stimulator device in accordance with the present invention.

FIG. 2 shows various components of the SCS system of FIG. 1.

FIG. 3 shows a block diagram that illustrates the main components of one embodiment of an implantable stimulator device in which the invention can be used.

FIG. 4 shows a block diagram that illustrates another embodiment of an implantable stimulator device in which the invention can be used.

FIG. 5 shows the RF-telemetry circuitry useable in an implantable stimulator, and specifically shows an example of analog demodulation circuitry which may be used.

FIG. 6 shows the demodulation circuitry useable in an implantable stimulator in accordance with one embodiment of the invention.

FIG. 7 shows the digital portions of the demodulation circuitry of FIG. 6 in further detail and as implemented in a microprocessor.

FIG. 8 shows simulated circuit traces illustrating the operation of the circuitry of FIGS. 6 and 7.

FIG. 9 shows another embodiment of demodulation circuitry useable in an implantable stimulator in accordance with one embodiment of the invention, in which standard radio components are used.

### DETAILED DESCRIPTION

The following description is of the best mode presently contemplated for carrying out the invention. This description is not to be taken in a limiting sense, but is made merely for the purpose of describing the general principles of the invention. The scope of the invention should be determined with reference to the claims and their equivalents.

Before discussing the telemetry-based aspects of the invention, and in particular the demodulation circuitry and technique that is the focus of this disclosure, the circuitry, structure, and function of an implantable stimulator device in which the disclosed circuitry and technique can be used is set forth for completeness. The disclosed implantable stimulator device may comprise implantable pulse generator (IPG), or similar electrical stimulator and/or electrical sensor, that may be used as a component of numerous different types of stimulation systems. More specifically, the description that follows relates to use of the invention within a spinal cord stimulation (SCS) system as an exemplary embodiment. However, it is to be understood that the invention is not so limited. Rather, the invention may be used with any type of implantable electrical circuitry that could benefit from improved demodulation techniques. For example, the present invention may be used as part of a pacemaker, an implantable pump, a defibrillator, a cochlear stimulator, a retinal stimulator, a stimulator configured to produce coordinated limb movement, a cortical or deep brain stimulator, or in any other stimulator configured to treat urinary incontinence, sleep apnea, shoulder sublaxation, etc. Moreover the demodulation technique can be used in non-medical and/or non-implantable devices or systems as well, i.e., in any communication device or system in which efficient and simple demodulation is desirable.

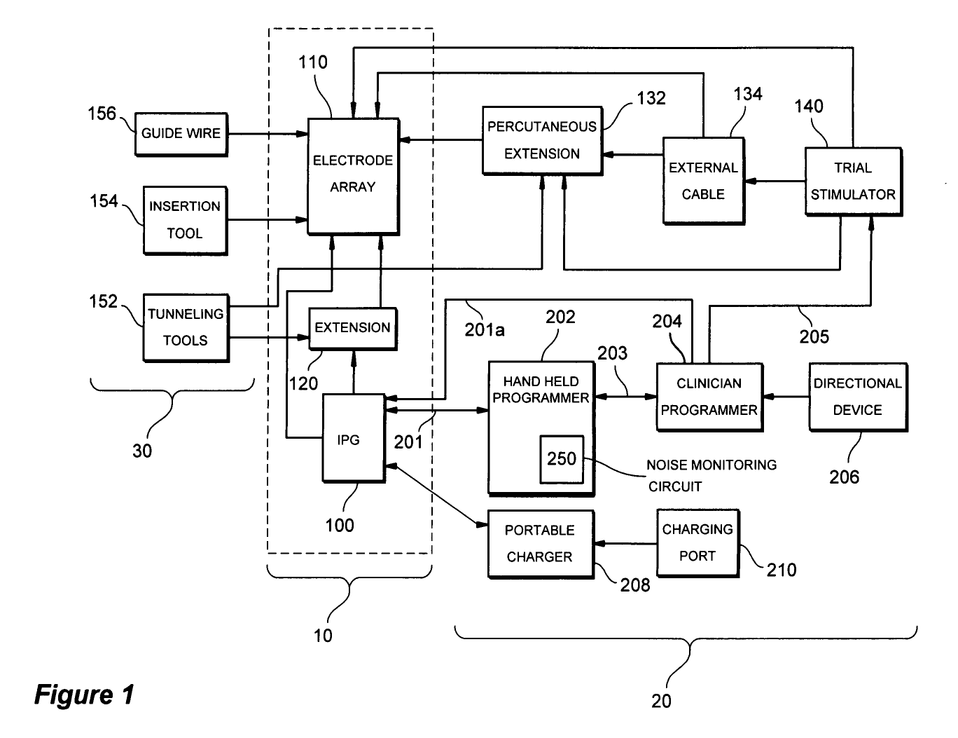

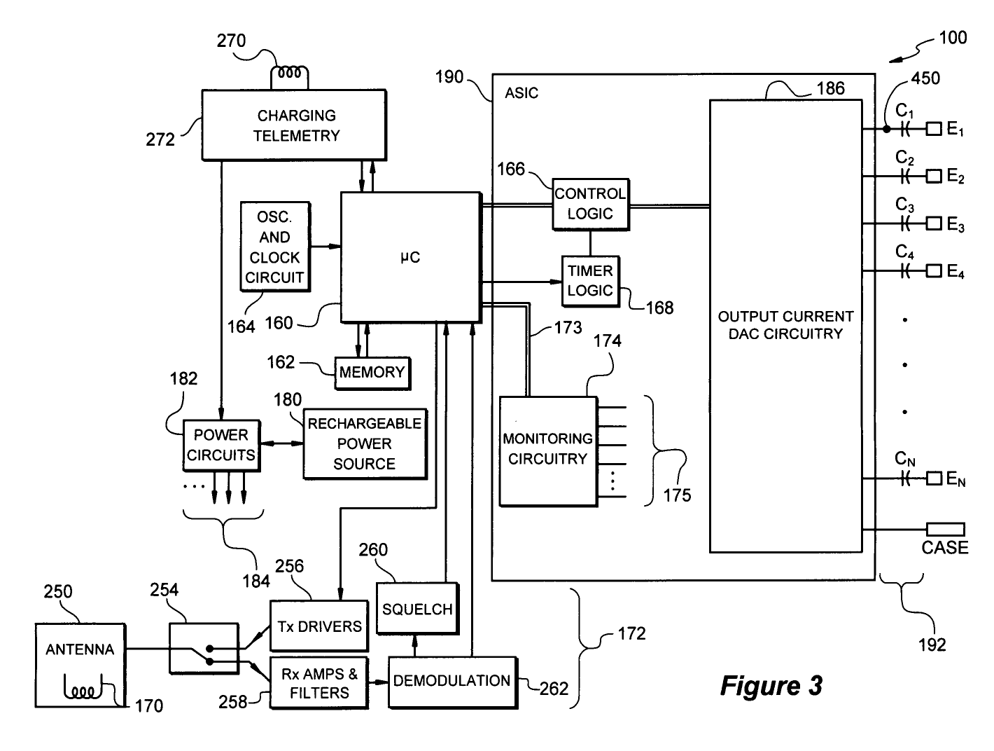

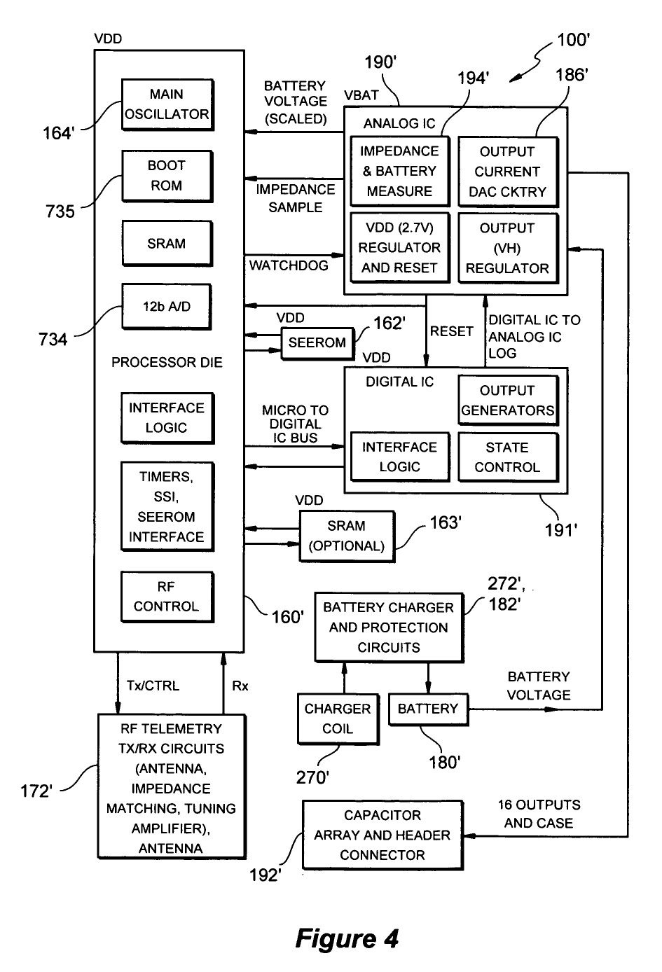

Turning first to FIG. 1, a block diagram is shown that illustrates the various components of an exemplary SCS system in which the invention may be used. These components may be subdivided into three broad categories: implantable components 10, external components 20, and surgical components 30. As seen in FIG. 1, the implantable components 10 include an implantable pulse generator (IPG) 100, an electrode array 110, and (as needed) a lead extension 120. The extension 120 may be used to electrically connect the electrode array 110 to the IPG 100. In an exemplary embodiment, the IPG 100, described more fully below in connection with FIG. 3 or 4, may comprise a rechargeable, multi-channel, telemetry-controlled, pulse generator housed in a rounded high-resistivity titanium alloy case to reduce eddy current heating during the inductive charging process. The IPG 100 may provide electrical stimulation through a multiplicity of electrodes, e.g., sixteen electrodes E₁ through E₁₆, included within the electrode array 110.

In this regard, the IPG 100 may include stimulating electrical circuitry (“stimulating electronics”), a power source, e.g., a rechargeable battery, and a telemetry system, the latter of which is particularly relevant to embodiments of the disclosed invention. Typically, the IPG 100 is placed in a surgically-made pocket either in the abdomen, or just at the top of the buttocks. It may, of course, also be implanted in other locations of the patient's body. Once implanted, the IPG 100 is connected to the lead system, comprising the lead extension 120, if needed, and the electrode array 110. The lead extension 120, for example, may be tunneled up to the spinal column. Once implanted and any trial stimulation period is complete, the lead system 110 and lead extension 120 are intended to be permanent. In contrast, the IPG 100 may be replaced when its power source fails or is no longer rechargeable.

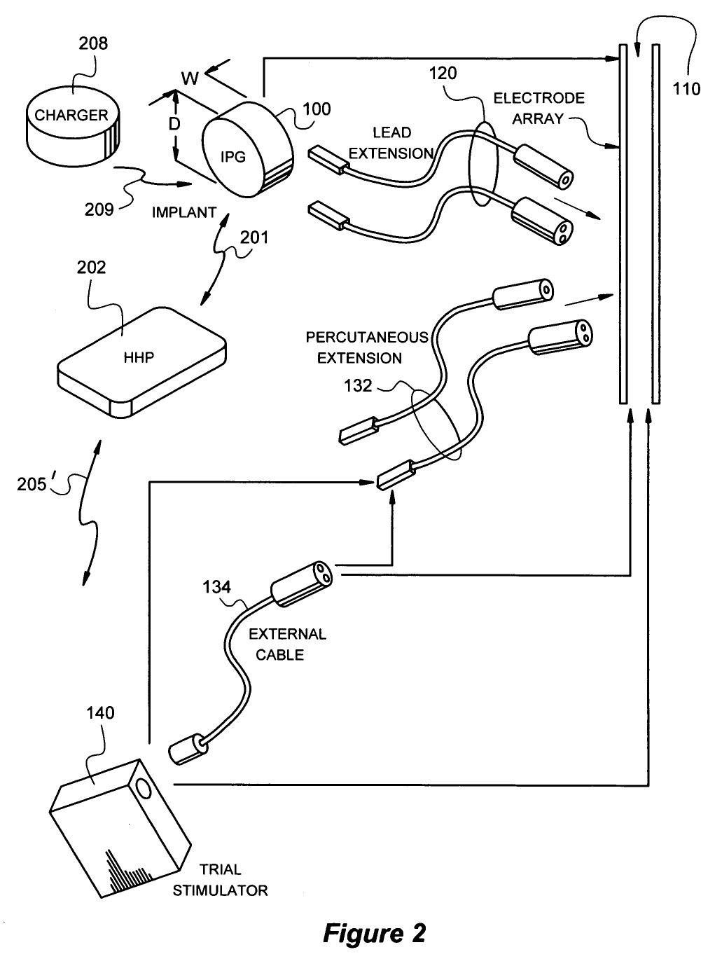

As seen best in FIG. 2, and as also illustrated in FIG. 1, the electrode array 110 and its associated lead system typically interface with the implantable pulse generator (IPG) 100 via the lead extension system 120 just mentioned. The electrode array 110 may also be connected to an external trial stimulator 140, through the use of a percutaneous lead extension 132 and/or an external cable 134. The external trial stimulator 140 typically includes the same or similar pulse generation circuitry as does the IPG 100, and is used on a trial basis, e.g., for 7-10 days, after the electrode array has been implanted and prior to implantation of the IPG 100, to test the effectiveness of the stimulation that is to be provided.

Still with reference to FIGS. 1 and 2, and as noted earlier, a hand-held programmer (HHP) 202 may be used to control the IPG 100 via a suitable non-invasive communications link 201, e.g., an RF link. Such control allows the IPG 100 to be turned on or off, and generally allows stimulation parameters, e.g., pulse amplitude, width, and rate, to be set by a patient or clinician within prescribed limits. The HHP 202 may also be linked with the external trial stimulator 140 through another link 205′, e.g., an infra red link. Detailed programming of the IPG 100 is preferably accomplished through the use of an external clinician's programmer (CP) 204 (FIG. 1), which may also be hand-held and which may be coupled to the IPG 100 directly via link 201a or indirectly through the HHP 202. An external charger 208, non-invasively coupled with the IPG 100 through link 209, e.g., an inductive link, allows energy stored or otherwise made available to the charger 208 to be coupled into the rechargeable battery housed within the IPG 100, as explained further below.

Turning next to FIG. 3, a block diagram is shown that illustrates the main components of one embodiment of an implantable pulse generator (IPG) 100 in which embodiments of the invention may be used. As seen in FIG. 3, the IPG includes a microcontroller (μC) 160 connected to memory circuitry 162. The μC 160 typically comprises a microprocessor and associated logic circuitry, which in combination with control logic circuits 166, timer logic 168, and an oscillator and clock circuit 164, generate the necessary control and status signals which allow the μC 160 to control the operation of the IPG in accordance with a selected operating program and stimulation parameters. (A “microcontroller” as used herein should be understood as any integrated device capable of processing signals in the IPG, including traditional microcontrollers, microprocessors, or other signal processors, including those that are application-specific, such as ASIC chips).

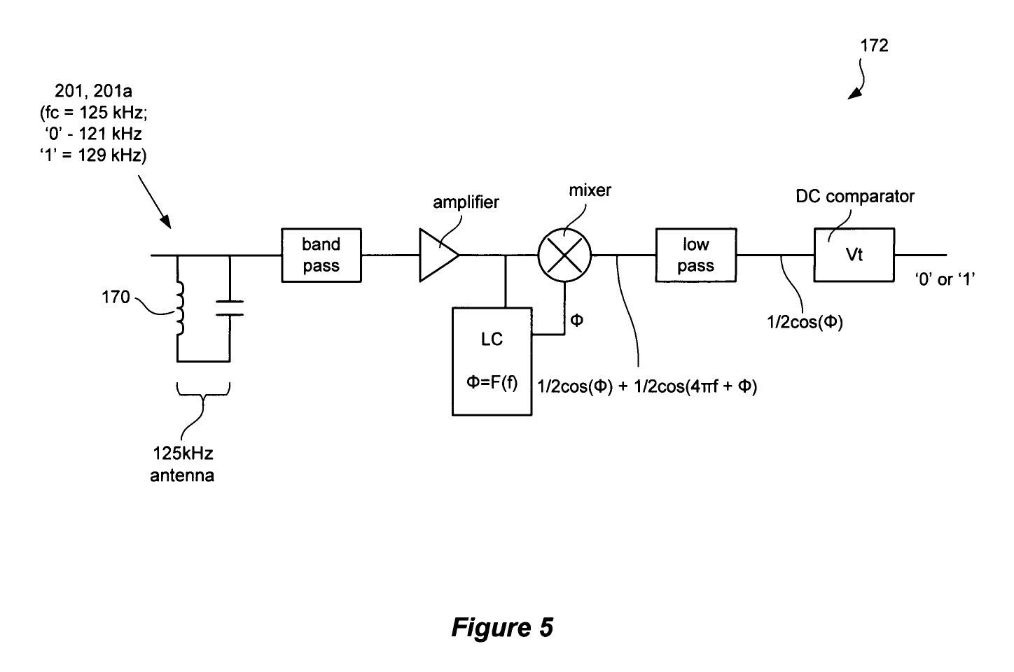

The operating program and stimulation parameters are telemetered to the IPG 100, where they are received via antenna 250 (which may include a coil 170 and/or other antenna components), processed, e.g., via RF-telemetry circuitry 172, and may be stored, e.g., within the memory 162. As noted earlier, the RF-telemetry circuitry 172 demodulates the signal it receives from the HHP 202 or CP 204 to recover the operating program and/or the stimulation parameters. More specifically, signals received by the antenna 250 are passed through the transmit/receive switch 254 to amplifiers and filters 258 (see also FIG. 5). From there, the received signals are demodulated (262) using Frequency Shift Keying (FSK) demodulation for example, and the data is then sent to the microcontroller 160 for processing and/or eventual storage. When RF-telemetry circuitry 172 is used to transmit information to the HHP 202 or CP 204 to report in some fashion on its status, the microcontroller 160 sends relevant data to transmission drivers 256, where the carrier is modulated by the data and amplified for transmission. The transmit/receive switch 254 would then be set to communicate with the transmission drivers 256, which in turn drive the data to the antenna 250 to be broadcast.

The microcontroller 160 is further coupled to monitoring circuits 174 via bus 173. The monitoring circuits 174 monitor the status of various nodes or other points 175 throughout the IPG 100, e.g., power supply voltages, current values, temperature, the impedance of electrodes attached to the various electrodes E₁ . . . E_{N}, and the like. Informational data sensed through the monitoring circuit 174 may be sent to a remote location external to the IPG (e.g., a non-implanted location) through telemetry circuitry 172 via coil 170.

The operating power for the IPG 100 may be derived from a rechargeable power source 180, which may comprise a lithium-ion or lithium-ion polymer battery, for example. The rechargeable battery 180 provides an unregulated voltage to power circuits 182. The power circuits 182, in turn, generate the various voltages 184, some of which are regulated and some of which are not, as needed by the various circuits located within the IPG 100. In a preferred embodiment, the battery 180 is charged by an electromagnetic field created by an external portable charger 208 (FIG. 1). When placed near the IPG 100 (e.g., centimeters away), an electromagnetic field emanating from the portable charger 208 induces a current in charging coil 270 (even through a patient's skin). This current is then rectified and regulated to charge the battery 180. Further associated with the charging circuitry is charging telemetry circuitry 272, which is used for example by the IPG 100 to report back to the portable charger 208 when the battery is full, and thus when portable charger can be shut off.

In one exemplary embodiment, any of the N electrodes may be assigned to up to k possible groups or “channels.” In one preferred embodiment, k may equal four. Moreover, any of the N electrodes can operate, or be included in, any of the k channels. The channel identifies which electrodes are selected to synchronously source or sink current to create an electric field in the tissue to be stimulated. Amplitudes and polarities of electrodes on a channel may vary, e.g., as controlled by the HHP 202. External programming software in the CP 204 is typically used to set parameters including electrode polarity, amplitude, pulse rate and pulse width for the electrodes of a given channel, among other possible programmable features.

The N programmable electrodes can be programmed to have a positive (sourcing current), negative (sinking current), or off (no current) polarity in any of the k channels. Moreover, each of the N electrodes can operate in a bipolar mode or multipolar mode, e.g., where two or more electrode contacts are grouped to source/sink current at the same time. Alternatively, each of the N electrodes can operate in a monopolar mode where, e.g., the electrode contacts associated with a channel are configured as cathodes (negative), and the case electrode (i.e., the IPG case) is configured as an anode (positive).

Further, the amplitude of the current pulse being sourced or sunk to or from a given electrode contact may be programmed to one of several discrete current levels, e.g., between 0 to 10 mA in steps of 0.1 mA. Also, the pulse width of the current pulses is preferably adjustable in convenient increments, e.g., from 0 to 1 milliseconds (ms) in increments of 10 microseconds (μs). Similarly, the pulse rate is preferably adjustable within acceptable limits, e.g., from 0 to 1000 Hz. Other programmable features can include slow start/end ramping, burst stimulation cycling (on for X time, off for Y time), and open or closed loop sensing modes.

The stimulation pulses generated by the IPG 100 may be charge balanced. This means that the amount of positive charge associated with a given stimulus pulse is offset with an equal and opposite negative charge. Charge balance may be achieved through coupling capacitors C_{X}, which provide a passive capacitor discharge that achieves the desired charge-balanced condition. Alternatively, active biphasic or multi-phasic pulses with positive and negative phases that are balanced may be used to achieve the needed charge balanced condition.

In short, the IPG 100 is able to individually control the currents at the N electrodes. Controlling the output current Digital-to-Analog Current (DAC) circuitry 186 using the microcontroller 160, in combination with the control logic 166 and timer logic 168, allows each electrode contact to be paired or grouped with other electrode contacts, including the monopolar case electrode, to control the polarity, amplitude, rate, pulse width and channel through which the current stimulus pulses are provided.

As shown in FIG. 3, much of circuitry included within the IPG 100 may be realized on a single application specific integrated circuit (ASIC) 190. This allows the overall size of the IPG 100 to be quite small, and readily housed within a suitable hermetically-sealed case. The IPG 100 may include N feedthroughs to allow electrical contact to be individually made from inside of the hermetically-sealed case with the N electrodes that form part of the lead system outside of the case.

As noted earlier, in use, the IPG 100 may be placed in a surgically-made pocket, e.g., in the abdomen or just at the top of the buttocks, and detachably connected to the lead system (comprising optional lead extension 120 and electrode array 110). While the lead system is intended to be permanent, the IPG 100 may be replaced should its power source fail, or for other reasons.

The telemetry features of the IPG 100 allow the status of the IPG to be checked as noted earlier. For example, when the HHP 202 and/or the CP 204 initiate a programming session with the IPG 100 (FIG. 1), the capacity of the battery is telemetered so that the external programmer can calculate the estimated time to recharge. Any changes made to the current stimulus parameters are confirmed through back-telemetry, thereby assuring that such changes have been correctly received and implemented within the implant system. Moreover, upon interrogation by the external programmer, all programmable settings stored within the implant system 10 may be uploaded to one or more external programmers.

Turning next to FIG. 4, a hybrid block diagram of an alternative embodiment of an IPG 100′ that may be used with the invention is illustrated. The IPG 100′ includes both analog and digital dies, or integrated circuits (ICs), which may be housed in a single hermetically-sealed rounded case having, for instance, a diameter of about 45 mm and a maximum thickness of about 10 mm. Many of the circuits contained within the IPG 100′ are identical or similar to the circuits contained within the IPG 100, shown in FIG. 3. The IPG 100′ includes a processor die, or chip, 160′, an RF telemetry circuit 172′ (typically realized with discrete components), a charger coil 270′, a rechargeable battery 180′, battery charger and protection circuits 272′, 182′, memory circuits 162′ (SEEPROM) and 163′ (SRAM), a digital IC 191′, an analog IC 190′, and a capacitor array and header connector 192′.

The capacitor array and header connector 192′ include sixteen output decoupling capacitors, as well as respective feed-through connectors for connecting one side of each decoupling capacitor through the hermetically-sealed case to a connector to which the electrode array 110, or lead extension 120, may be detachably connected.

The processor 160′ may be realized with an application specific integrated circuit (ASIC), field programmable gate array (FPGA), or the like that comprises a main device for full bi-directional communication and programming. The processor 160′ may utilize an 8086 core (the 8086 is a commercially-available microprocessor available from, e.g., Intel), or a low power equivalent thereof, SRAM or other memory, two synchronous serial interface circuits, a serial EEPROM interface, and a ROM boot loader 735. The processor die 160′ may further include an efficient clock oscillator circuit 164′, and (as noted earlier) mixer and modulator/demodulator circuitry implementing the QFAST RF telemetry method. An analog-to-digital converter (A/D) circuit 734 is also resident on the processor 160′ to allow monitoring of various system level analog signals, impedances, regulator status and battery voltage. The processor 160′ further includes the necessary communication links to other individual ASICs utilized within the IPG 100′. The processor 160′, like all similar processors, operates in accordance with a program that is stored within its memory circuits.

The analog IC (AIC) 190′ may comprise an ASIC that functions as the main integrated circuit that performs several tasks necessary for the functionality of the IPG 100′, including providing power regulation, stimulus output, and impedance measurement and monitoring. Electronic circuitry 194′ performs the impedance measurement and monitoring function.

The analog IC 190′ may also include output current DAC circuitry 186′ configured to supply current to a load, such as tissue, for example. The output current DAC circuitry 186′ may be configured to deliver up to 20 mA aggregate and up to 12.7 mA on a single channel in 0.1 mA steps. However, it will be noted that the output current DAC circuitry 186′ may be configured to deliver any amount of aggregate current and any amount of current on a single channel, according to one exemplary embodiment.

Regulators for the IPG 100′ supply the processor and the digital sequencer with a voltage. Digital interface circuits residing on the analog IC 190′ are similarly supplied with a voltage. A programmable regulator supplies the operating voltage for the output current DAC circuitry 186′. The coupling capacitors C_{X} and electrodes E_{X}, as well as the remaining circuitry on the analog IC 186′, may all be housed within the hermetically sealed case of the IPG 100. A feedthrough pin, which is included as part of the header connector 192′, allows electrical connection to be made between each of the coupling capacitors CN and the respective electrodes E₁, E₂, E₃, . . . or E₁₆.

The digital IC (DigIC) 191′ functions as the primary interface between the processor 160′ and the output current DAC circuitry 186′, and its main function is to provide stimulus information to the output current DAC circuitry 186′. The DigIC 191′ thus controls and changes the stimulus levels and sequences when prompted by the processor 160′. In an exemplary embodiment, the DigIC 191′ comprises a digital application specific integrated circuit (digital ASIC).

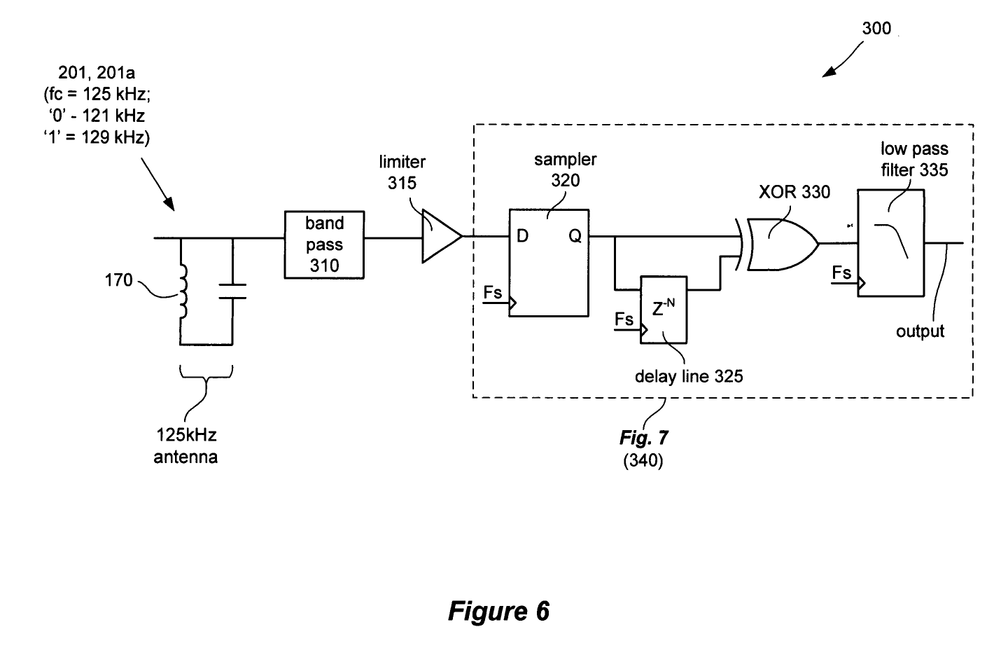

With the basic structure of an implantable stimulator understood, focus now shifts to a detailed description of the demodulation circuitry and techniques that are the focus of this disclosure. Such demodulation circuitry 340, and the receiver circuitry 300 of which it is a part, is shown at a high level in FIG. 6. It is again worth noting that while particularly useful when implemented in implantable medical devices, the disclosed demodulation circuitry and techniques can benefit any device or communication system in which low power consumption and/or simpler circuit implementations are beneficial. Thus, disclosure in the context of an implantable medical device should be understood as merely exemplary.

As one skilled will appreciate, demodulation circuitry 340 is digital in nature, which as noted earlier is preferred for its integrated convenience when compared with analog components. However, commensurate with the analog nature of the RF signals that receiver circuitry 300 receives, the circuit also contains analog components such as an antenna which includes coil 170 (see FIG. 6), and a band pass filter 310 to remove frequencies outside of the frequencies of interest (e.g., those above 129 kHz (logic ‘1’) and those below 121 kHz (logic ‘0’)). As concerns these analog components, receiver circuit 300 is not different from the analog implementation discussed earlier with reference to FIG. 5. Use of band pass filter 310, while preferred to improve circuit performance and to reduce error rates, is optional.

Reflective of the digital nature of the circuitry that follows, the output of the band pass filter 310 is sent to a limiter 315, which as one skilled in the art will understand operates to turn the low amplitude received sinusoidal signals into logic-level square wave signals.

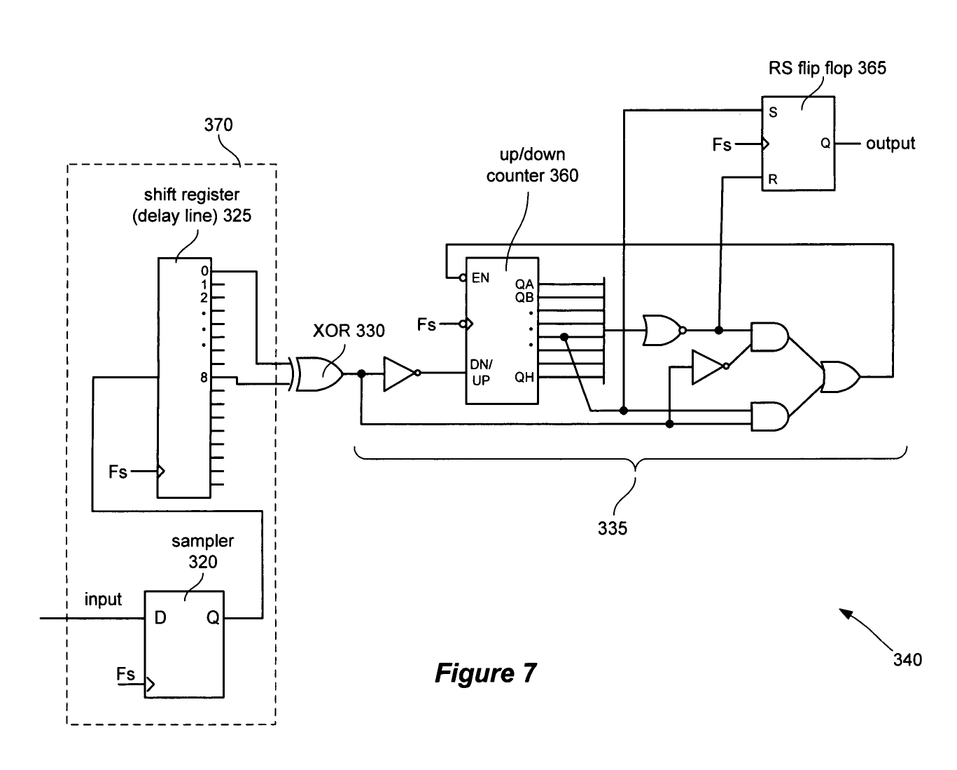

Once the received telemetry signals are filtered and processed as just described, they are sent to a sampling circuit 320 (i.e., sampler) (see FIG. 6), which comprises the beginning of the digital demodulator circuitry 340, and which will be discussed in further detail with respect to FIG. 7. The sampling circuit 320, as its name suggests, samples the signal at periodic time intervals in accordance with a sampling clock signal, Fs, which will be described in further detail below. In a preferred embodiment, the sampler 320 can comprise a D flip-flop clocked by Fs, but could comprise other structures as well. Through sampling, the received telemetry signals are effectively digitized into ‘0’ and ‘1’ values.

Thereafter, the now-digitized received signals are sent to an exclusive OR (‘XOR’) logic gate 330 and to a delay line 325. The functions of the XOR gate 330 and the delay line 325 are somewhat analogous to the mixer and the LC circuit of the analog demodulator circuit of FIG. 5. Thus, the delay line 325 works to delay the output of the sampler 320 by a certain number of cycles of the sampling clock Fs (i.e., N cycles), and both the delayed samples and undelayed (original) samples are sent to the XOR gate 330, where they are compared for a “match” condition. If equal, the XOR gate outputs a logic ‘0,’ and if not a ‘1’. (An XNOR gate, i.e., equivalent in logic to an XOR gate but with an inverted output, could also be used).

Without delving into a detailed discussion of the mathematics at hand, the low-pass-filtered output of the XOR gate 330 is the signal of interest which allows for the differentiation between data bit ‘0’ and ‘1’. The output of the XOR gate 330 is preferably sent to a filter 335, which as will be discussed further below, operates like an integrator to smooth out “glitches” in the data that might be present in the output of the XOR gate. However, filtering, while beneficial, is not strictly required, and in certain instances the raw output of the XOR gate 330 can be used as the final representation of the demodulated data, particularly if other measures are taken earlier in the circuitry 340 to ensure that the XOR gate 330's output will not be overly noisy.

With this high level review of the receiver circuitry 300 understood, further details of its digital demodulator 340 can be better appreciated, and are shown in FIG. 7. However, before discussing these details, it is worth noting that the circuitry in the digital demodulator 340 of the receiver circuit 300 may be fully implemented in a single microcontroller, such as that already present in the IPG 100 (e.g., elements 160 of FIG. 3 or 160′ of FIG. 4). This is a significant improvement over previous approaches which required (in addition to the microcontroller) large, power-consuming analog components, and/or complicated or specialized digital signal processing hardware and techniques. By contrast, the disclosed solution, because of its simplicity, is implementable using the microcontroller, thus saving space in the IPG, and alleviating the need for other space- and power-consuming electronics for demodulation. In short, the disclosed demodulation circuitry is more efficient than previous approaches. That being said, it is still logical that some portions of the receiver circuitry 300 remain as discrete analog components, such as the antenna, band pass filter 310, and limiter circuitry 315 (see FIG. 6), although it may be possible to integrate some or all of the components of the receiver circuitry 300 into a single integrated circuit, or to further integrate such components together with the digital demodulator 340. Ultimately, the specific implementation details (analog v. digital, integrated v. non-integrated) are not critical to all useful embodiments of the invention. A microcontroller suitable for implementation of the disclosed demodulation technique (and also suitable to perform other necessary IPG logic processing functions) is the Texas Instruments model number MSP430.

FIG. 7 shows further details of the digital demodulator 340 of the receiver circuitry 300. The delay line 325 is preferably implemented using a shift register. In the example shown in FIG. 7, the samples are shifted (i.e., delayed) by eight cycles of the sample clock, Fs, a number which is implementation-specific as will be explained in further detail below. Both the sampler 320 and shift register 325 can be implemented with the standard UART (Universal Asynchronous Receiver Transmitter) hardware portion 370 of the microcontroller. It will be clear to one skilled in the art that if sampler 320 is implemented as a D flip-flop, then the sampler can become the 0th element of the shift register 325.

Ultimately, the delayed and non-delayed versions of the sampled signal are sent to XOR gate 330, whose output is then subsequently smoothed at filter 335, as will be explained further below. When implemented in a microcontroller, XOR gate 330 and filter 335 are preferably implemented through software programming of the microcontroller. However, it should also be realized that these logical functions can also be implemented in hardware, e.g., in a specialized ASIC chip, etc.

With the details of the digital demodulator 340 set forth, operational details are now further discussed, starting with a discussion of the delay line (e.g., shift register) 325 and the sampling clock rate, Fs. In a preferred embodiment, the delay line 325 is set to provide a 90-degree phase shift for an incoming frequency of f_{c}. For example, assuming f_{c}=125 kHz, a 90-degree phase shift can be obtained by sampling at Fs=500 kHz (4×125 kHz) and using a delay in the shift register of one cycle. The sampling rate and/or the delay can be optimized for a given system. For example, if a delay of one cycle provides a 90-degree phase shift, a delay of two cycles would give a 180-degree phase shift, a delay of three cycles would give a 270-degree phase shift, etc. Thus, continuing the example, delay values of 1, 5, 9, 13 cycles, etc, all provide 90 degrees of phase shift; delay values of 3, 7, 11, 15 cycles, etc. all provide 270 degrees of phase shift, which results in inverted data as compared to the 90-degree phase shift. Of course, these delay values will change if the sampling frequency Fs is changed.

To summarize, the relationship between the sampling frequency Fs, the center frequency f_{c}, the number of delays N, and the scalar M, is Fs=4Nf_{c}/M, where N=1, 2, 3, and M=1, 3, 5, 7, etc., where parameters N and M are set to values suitable for the hardware to be used. When implemented in a microprocessor for example, as discussed further below, the sampling rate Fs needs to be reduced to a rate low enough for the microprocessor to be able to process the samples in real time, but high enough to ensure the minimum sampling rate as required by the Nyquist criteria, which states that a signal should be sampled at at least twice of its bandwidth. Thus, to properly sample a signal centered at f_{c}=125 kHz with a bandwidth of 12 kHz (the practical bandwidth in the example set forth), the minimum sampling rate is 24 kHz, although for the purpose of maintaining good signal fidelity the sample rate can be increased to a higher rate. It is also desirable to set the parameters such that the delay N required to provide a 90-degree phase shift is the same as the size of the byte created by the UART 370 (typically 8 eight bits). This allows the XOR operation to be performed on successive bytes (i.e., Sample-Byte(n) XORed with Sample-Byte(n−1) where byte-wise XOR operation is performed pursuant to the ANSI C standard), with the resultant value processed by a the low pass filter 325 as explained further below.

However, there is an upper limit to the length of the delay line 325, i.e., the number of cycles of delay it can impart. If the delay in terms of number of cycles becomes excessively long, the XOR gate 330 will see an overlap in samples which correspond to a data bit ‘0’ and data bit ‘1’, which is not desirable. Experimentation suggests that the maximum delay time that can be used before performance degrades is about ⅓ of a data bit time. For example, if Fs=500 kHz, and if data is transferred at a rate of 4000 bps (bits per second), the maximum delay would be approximately ⅓ times 1/4000, or 83 μs, which would correspond to 41 cycles at 500 kHz. Thus, when a shift register is used to provide the delay as shown in FIG. 7, the 41st tap would be input to the XOR gate 330.

Sampling rates can be reduced from traditional values using the disclosed approach without compromising performance. For example, sampling at 250 kHz, 333.3 kHz, or 500 kHz would give the same results as sampling at the higher rate of 1 MHz, and all of these are above the minimum sampling rate of 24 kHz. Not only are reduced sampling rates acceptable, they can be beneficial because they will result in lower power consumption, and a lower use of computing resources in the microcontroller, which might not be able to process the samples in real time if sampling rates are too high. If reduced sampling rates are used, consideration should also be given to the delay line (shift register) 325, the length of which can be computed from the relationship Fs=4Nf_{c}/M discussed earlier.

With the above as background, attention can now be drawn to simulated parameters useable for demodulation circuitry 340, which for exemplary purposes comprises parameters useable in an IPG system. As an example, in one embodiment the microprocessor runs from a 4 MHz clock with the UART 370 set to generate 8-bit wide samples. The signal to be sampled is centered at f_{c}=125 kHz with a practical bandwidth of 12 kHz. In this embodiment, one can choose the delay value N=8 (consistent with the 8 sample bits provided by the UART 370 as noted earlier) and can set the scalar M=27. Thus, using the formula introduced earlier, Fs=(4)(8)(125k)/27=148.148 kHz, a frequency easily generated from the 4 MHz clock, and well above the sampling limit of the Nyquist criteria. Using such parameters, the UART 370 generates a sample-byte every 54 microseconds (8/148.148 kHz), which is long enough for the microprocessor to process the data in real time. These parameters result in a 270-degree phase shift, which provides inverted data, but the data is easily inverted later if it is not suitable to use in inverted form. Of course, these values are simply reflective of one simulation made in light of assumed hardware constraints; other values are permissible in other embodiments.

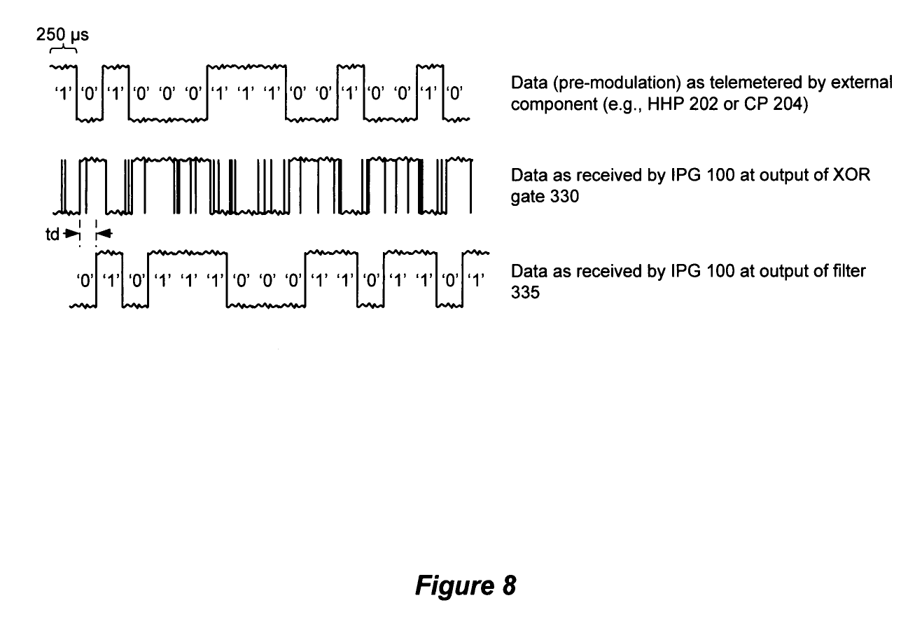

Simulated circuit traces based on these parameters are shown in FIG. 8. The first trace represents the serial stream of data bits which are to be telemetered from an external component (i.e. the data used to modulate the carrier in the HHP 202 or CP 204 FSK transmitter). The second trace represents the data as received at the output of the XOR gate 330. As can be seen, this output is rather noisy due to undesired high frequency effects, but an outline of the inverted data is visible, and hence is potentially useable as the final representation of the demodulated data even without further processing. However, such noise in the XOR output can be filtered out with low probability of error using filter 335 as reflected in the third trace, which now very clearly reveals the telemetered data as demodulated, and therefore which preferably comprises the final representation of the data. In short, through use of the disclosed, simplified demodulation circuitry 330, the bit stream to be telemetered is reconstituted in the IPG (albeit in this example in inverted form due to the 270-degree delay). (As denoted in FIG. 6, the processing at the filter 335 imparts a delay td, which is approximately 100 μs as simulated). In other words, whether filter or unfiltered, and whether inverted or non-inverted, the result is a demodulated output indicative of the series of data bits represented by the modulated signal.

As noted earlier, the filter 335 is preferably implemented in software by programming the microcontroller. However, a circuit representation reflective of such programming in one exemplary implementation is shown in FIG. 7, although it should be stressed that this is merely one exemplary way of filtering the received and demodulated data. Filter 335 employs an up/down counter circuit 360 that increments binary outputs QA-QX when the output of the XOR gate 330 is high and decrements when the output of the XOR gate 330 is low. The various logic gates coupled to the outputs of the counter circuitry 360 feed back to the enable control (EN) of the counter 360, which limits the counter to output values from 0 (i.e., 00000) to 16 (i.e., 10000), an implementation-specific parameter. When the count gets to 0, the SR flip flop 365 is reset, indicating receipt of logic ‘0’ bit, and when the count gets to 16, the SR flip flop 365 is set indicating receipt of a logic ‘1’ bit. In this way, the counter circuit 360 acts similarly to an integrator or 1st order low pass filter. However, it should be realized that other filter circuitry could be used, such as analog filter circuitry (e.g., operational amplifier circuitry).

Software to emulate the functionality of FIG. 7 is set forth below in C programming code. As noted, such coding can be programmed into the microcontroller or a similar programmable device if it is used, which as noted above is a preferred implementation in some embodiments. To perform the demodulation function in real time, the demodulation and low pass filter routine should be computationally efficient. To reduce the number of instructions the microcontroller must perform, the microcontroller's UART 370 is configured for 8 bit data, such that the samples of the received signal to be demodulated are processed 8 samples at a time.

In accordance with the C code below, the UART and its interrupt service routine are configured to store 8-bit values in an array named “Buffer.” The variable named “Index” represents the current sample. The array named “BitSum” contains the sum of the bit values for the integer values 0 to 15 where a ‘0’ bit is treated as −1. For example, the value 0 is represented as “0000” so its Bit Sum is −4 (4×−1). The value 1 is represented as “0001” so its Bit Sum is −2 (3×−1+1) etc.

The XOR operation is performed byte-wise on successive values coming from the UART per the ANSI C standard. Thus there is a delay of 8 between each of the bits being XORed. “XorValue” is processed a nibble at a time with a routine that simulates the low pass filter 335 of FIG. 7. The value of “Bit” represents the demodulated data, and if used to control an output pin on the microcontroller, the demodulated data becomes readily apparent. The constant “MAX” was set to 6, but is implementation specific. The C code below implements the above as described, although of course such coding is merely one way of programming a microcontroller to implement embodiments of the invention, and so should not be construed as limiting:

BitSum[16] = {−4,−2,−2,0,−2,0,0,2,−2,0,0,2,0,2,2,4};
XorValue = Buffer[Index] \hat{ } Buffer[Index−1];
Sum+= BitSum[XorValue & 0x0F];
if (Sum<= 0)
{

Sum= 0;
Bit = 1;

}
else if (Sum>= MAX)
{

Sum= MAX;
Bit = 0;

}
Sum+= BitSum[XorValue >> 4];
if (Sum<= 0)
{

Sum= 0;
Bit = 1;

}
else if (Sum>= MAX)
{

Sum= MAX;
Bit = 0;

}

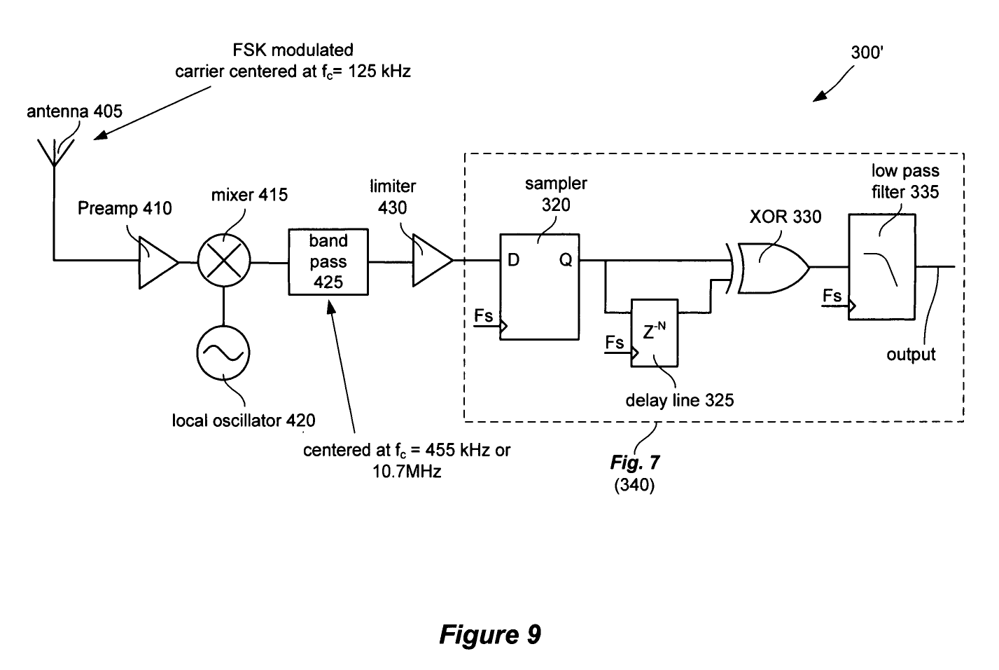

FIG. 9 represents another implementation of a receiver circuit 300′. In this embodiment, the digital demodulator 340 is unchanged, but the front-end analog circuitry is varied to include components typically used in radio design, such as in cellular telephones. This can facilitate design of the front end circuitry, as it allows for the use of standard components available for use at standard frequencies (e.g., 455 kHz). Thus, incoming telemetry centered at f_{c}=125 kHz is mixed to an intermediate frequency (e.g., 455 kHz) using standard radio components, i.e., antenna 405, preamp 410, mixer 415, and local oscillator 420, typically used for such an intermediate frequency. The signal at the intermediate frequency is then filtered by a band pass filter 425 and limited to a square wave at limiter 430. Because the intermediate frequency is different in this embodiment from examples discussed earlier, fresh consideration should be given to the sampling rate, Fs. Using the equation Fs=4Nf_{c}/M introduced earlier, and choosing N=40, f_{c}=455 kHz, and M=125 provides a sampling rate of Fs=582.4 kHz. (It should be clear that for a given intermediate frequency f_{c}, N and M are chosen to give a convenient sampling frequency).

To summarize, the disclosed demodulation circuitry is largely implementable using a microcontroller such as that already normally present in a telemetry receiving device such as an IPG (assuming an implementation employing a microprocessor is used). The digital portion of the demodulation circuitry is simple and, when a microcontroller is used, easy to implement using standard portions of the microcontroller (e.g., the UART) and/or through programming. The circuitry can sample the incoming telemetry signal at relatively low rates, thus saving power and microcontroller resources for other tasks. Only minimal analog components are required to receive the RF telemetry signal, and in a preferred embodiment no other dedicated circuitry is needed to implement the demodulation function, greatly simplifying the receipt of telemetry from a telemetry sending device, such as a HHP 202 or CP 204 in an IPG implementation.

While the invention herein disclosed has been described by means of specific embodiments and applications thereof, numerous modifications and variations could be made thereto by those skilled in the art without departing from the literal and equivalent scope of the invention set forth in the claims.

What is claimed is:

1. A method for demodulating a modulated signal from a sending device at a receiving device, where the modulated signal represents a series of data bits, the method comprising:
receiving the modulated signal at the receiving device via an antenna;
sampling the received signal with a sampling clock to create original samples of the received signal;
delaying the original samples by a number of cycles of the sampling clock to create delayed samples; and
processing the original samples and the delayed samples to form an output indicative of the series of data bits represented by the modulated signal.

2. The method of claim 1, wherein processing comprises use of digital filter circuitry.

3. The method of claim 1, wherein processing compares the original samples and the delayed samples for a matching condition.

4. The method of claim 1, wherein processing comprises the use of an XOR or XNOR logical operation.

5. The method of claim 1, wherein delaying the original samples comprises use of a shift register operable in accordance with the sampling clock.

6. The method of claim 1, further comprising, prior to sampling, passing the received signal through limiter circuitry.

7. The method of claim 1, further comprising, prior to sampling, mixing the received signal to an intermediate frequency.

8. The method of claim 1, further comprising, prior to sampling, amplifying and filtering the received signal.

9. The method of claim 1, wherein the modulated signal is or is adjusted to be centered at a frequency f_{c}, a rate of the sampling clock is Fs, the number of cycles is N, and wherein these parameters are related by the equation Fs=4f_{c}N/M, where M equals a positive odd whole number.

10. The method of claim 1, wherein the receiving device comprises an implantable medical device.

11. The method of claim 1, wherein the modulated signal comprises an FSK modulated signal.

12. A method for demodulating a modulated signal from a sending device at a receiving device, where the modulated signal represents a series of data bits, the receiving device including a microcontroller, the method comprising:
receiving the modulated signal at the receiving device via an antenna;
sampling the received signal at the microcontroller using a sampling clock to create original samples of the received signal;
delaying the original samples at the microcontroller using the sampling clock to create delayed samples; and
comparing at the microcontroller the original samples and the delayed samples to form an output indicative of the series of bits.

13. The method of claim 12, wherein comparing comprises use of digital filter circuitry.

14. The method of claim 12, wherein comparing comprises the use of an XOR or XNOR logical operation.

15. The method of claim 12, wherein delaying the original samples comprises use of a shift register in the microcontroller.

16. The method of claim 12, further comprising processing at the microcontroller signals other than the received signal.

17. The method of claim 12, wherein the receiving device comprises an implantable medical device.

18. A telemetry receiving device, comprising:
an antenna for receiving a modulated signal from a sending device at a receiving device, where the modulated signal represents a series of data bits;
a sampler for digitizing the received signal in accordance with a sampling clock to form original samples;
delay circuitry for creating delayed samples from the original samples, wherein the delayed samples are delayed with respect to the original samples by a number of cycles of the sampling clock; and
logic circuitry for comparing the original samples and the delayed samples to produce an output indicative of the series of bits.

19. The device of claim 18, wherein the logic circuitry comprises a digital filter to smooth the output.

20. The device of claim 18, wherein the logic circuitry comprises an XOR or XNOR gate.

21. The device of claim 18, wherein the delay circuitry comprises a shift register.

22. The device of claim 18, wherein the sampler, delay circuitry, and logic circuitry are all integrated in a microcontroller.

23. The device of claim 18, further comprising limiter circuitry interposed between the antenna and the sampler.

24. The device of claim 18, wherein the sampler and delay circuitry comprise a UART of a microcontroller.

25. The device of claim 18, wherein the logic circuitry comprises circuitry programmed in a microcontroller.

26. The device of claim 18, wherein the receiving device comprises an implantable medical device.
